(19) United States
(12) Patent Application Publication
(10) Pub. No.: US 2003/0004946 A1
(43) Pub. Date: Jan. 2, 2003

(54) Package labeling

(76) Inventors: Todd M. VanDenAvond, Cottage Grove, MN (US); John D. Sneden, Stillwater, MN (US); Chris Reed, Cottage Grove, MN (US)

Correspondence Address: Attention: Melissa E. Buss, Office of Intellectual Property Counsel, 3M Innovative Properties Company, P.O. Box 33427, St. Paul, MN, 55133-3427, US

(21) Appl. No.: 09/893,823

(22) Filed: Jun. 28, 2001

(51) Int. Cl. G06F 7/00

(52) U.S. Cl. 707/9

(57) ABSTRACT

Techniques are described for centrally managing labeling data of an organization, such as a corporation, and for sharing the labeling data in a secure manner between business units and remote manufacturing sites, print centers or other output locations. In this manner, the techniques provide a central system for controlling the output material that the organization applies to packaging and manufactured products. A label management software system is described that comprises a database to store configuration data defining an organization having a number of business units and manufacturing facilities. The label management system creates label records associated with the business units, and selectively prints labels at one the manufacturing systems based on the associated business units.

### TECHNICAL FIELD

The invention generally relates to manufacturing technologies and, more particularly, generating labeling and other printed material for packages.

### BACKGROUND

Each year, organizations ranging from sole proprietorships to large corporations produce and ship significant volumes of diverse products. The products, as well as the containers in which they are shipped, typically bear a variety of labels and other printed packaging materials. Each product may use a different container, requiring printed packaging material of different size and shape. In addition, a manufactured product may incorporate many packaging levels from the time the product comes off the manufacturing line to shipment. Furthermore, the format and content of the labels at each level may be highly regulated, as in the health care and pharmaceutical industries.

Large companies may use a number of different software tools to create and print the labels, such as graphics design and layout packages. Coordination of the various labels on a variety of packaging materials used throughout a company, and ensuring compliance with labeling regulations across all of the products, can be a significant challenge for an organization.

### SUMMARY

In general, the invention is directed to techniques for centrally managing the development of labeling data of an organization, such as a corporation, and for securely sharing the labeling data between business units and remote manufacturing sites, print centers or other output locations. In this manner, the techniques provide a central system for controlling the printed output material that the organization applies to packaging and manufactured products.

In one embodiment, the invention is directed to a label management system in which a database stores a label record having a publication status, such as draft or approved. The database includes configuration data defining a plurality of output locations, such as manufacturing facilities, and a plurality of groups of an organization, such as business units. Furthermore, the database associates the label record with one of the groups of the organization. A label record manager presents an interface for maintaining the label record and setting the publication status of the label record. An output manager prints a label at one of a plurality of output locations based on the label record and the publication status.

In another embodiment, the invention is directed to a label management system in which a database stores label records and associated label data. A label record manager controls the creation and modification of the label records and includes a revision control module to track changes made to the label records. The revision control module maintains modification logs for the label records and provides change histories for the label records.

In another embodiment, the invention is directed to a method including storing configuration data defining a plurality of organizations, each organization having at least one group and at least one output location. The method further includes presenting an interface by which each organization creates corresponding label records, and selectively printing labels at the corresponding output locations for the organizations.

These and other embodiments, including other systems, methods and computer-readable mediums that store instructions and data, are described in the specification and claims below. The invention provides many advantages, including allowing a corporation to develop a common management process across business units and manufacturing sites and, therefore, eliminate redundancies and inefficiencies inherent to a decentralized process.

The corporation may, for example, readily develop and manage standardized graphics for the various business units, allowing the company to provide more consistency and accuracy in the appearance of labels entering distribution channels and customer markets. The centralized label management system provides a centralized workspace by which users can collaborate to design and create labels and other printed material for new packages, and can reduce cycle times by facilitating the reuse of existing label templates and graphics.

Furthermore, the centralized label management system allows a corporation to more easily control and manage the available labels, including the various sizes, layouts, and formats, as well as the output mediums on which the labels are printed. In particular, multiple output locations, such as manufacturing facilities and print centers, receive the same labeling data and, therefore, can print identical labels and other print material for packages and manufactured products. The system also provides an efficient mechanism for rapid propagation of labeling changes throughout an organization.

Another advantage of a centralized labeling system is the ability to support relocation of products from one facility to another. In other words, because labeling data may be centrally managed, a company can relocate products from one manufacturing facility to another without needing to transfer labeling information. This process may be difficult with conventional desktop graphic design tools that execute on independent workstations.

The centralized label management system provides revision control modules for developing and maintaining labeling data. The system, for example, includes mechanisms for checking in and checking out label templates and graphics. The system may track modifications of labels and provide revision histories and other modification information.

Another advantage provided by the centralized label management system is to support and facilitate “on-demand” print systems by streamlining the delivery of label data to such systems when needed. In other words, label data can be quickly distributed to print systems when a company decides to manufacture a product, thereby allowing the company to satisfy any “just-in-time” manufacturing and supply contracts and other business relationships the company may service. In addition, the label management system supports “run-time” label fields that require information at the time of print, such as batch code, lot code, manufacture data, serial number and the like.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example label management system.

FIG. 2 is a block diagram illustrating the label management system of FIG. 1 in further detail.

FIG. 3 is a flowchart illustrating central management of labeling data for packaging and manufactured products according to the invention.

FIG. 4 illustrates an example web-based user interface presented by a template manager.

FIG. 5 illustrates an example web-based user interface presented by a graphics manager.

FIGS. 6-11 illustrate an example web-based user interface presented by a record manager.

FIGS. 12-14 illustrate an example web-based user interface presented by an output manager.

FIG. 15 is a block diagram illustrating a label management system that hosts labeling data for a plurality of organizations.

FIG. 16 illustrates example labels produced at an output location by a label management system in accordance with the invention.

### DETAILED DESCRIPTION

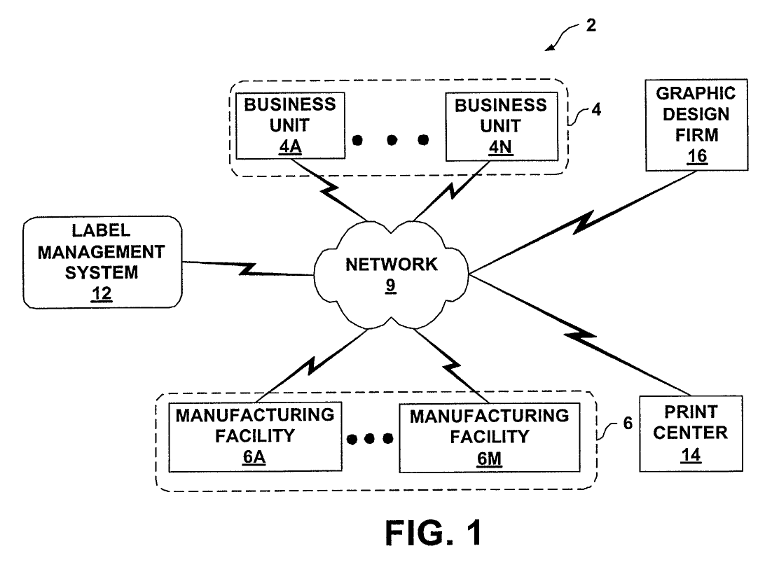

FIG. 1 is a block diagram illustrating a system 2 for centrally managing labeling data for packaging and manufactured products generally. More specifically, authorized users of business units 4A through 4N, collectively referred to as business units 4, for a corporation or other organization interact with label management system 12 via network 9 to develop and manage the packaging labels or other printed material for manufactured products. Remote manufacturing facilities 6, print centers 14 or other output locations interact with label management system 12 via network 9 to retrieve label data for company approved labels when packaging manufactured products.

Label management system 12 allows business units 4 and other remote users, such as graphic design firm 16, to define and approve labels including controlling all aspects and features of the printed label including size, layout, graphics, format, warning messages, and the like, as well as the output mediums and print devices on which the labels are printed. In this manner, label management system 12 allows the corporation to better control the layout and appearance of labels being presented to market by manufacturing facilities 6. In particular, label management system 12 ensures that manufacturing facilities 6 and other output locations, such as print center 14, receive the same labeling data and, therefore, print identical labels and other packaging material for manufactured products at different print locations. In addition, label management system 12 may be used to control labels used during the manufacturing process.

Label management system 12 can be used with any labeling device or system and can be used to print labels or other media, or can be used to print directly on packaging material such as folding cartons, boxes, flexible films or the like. Similarly, the label data, as defined herein, may be used for a variety of packaging purposes including, for example, to program radio frequency identification (RFID) tag fixed to products at the time of manufacturing. As examples, the RFID tag may be programmed with a lot code, a date of manufacture, a serial number, a UPC code or other label data.

Any authorized user within business units 4, manufacturing facilities 6, graphic design firm 16 or print service 14 can access label management system via network 9. A user can be any authorized individual, such as a packaging engineer within business unit 6A, a plant operator within manufacturing facility 6A, a graphic designer within graphic design firm 16, or a customer service representative within print center 14, and may be geographically distributed. By interacting with label management system 12, as described below, users 4 can create, update, and archive label data, as well as generate labels for manufactured products.

A graphic designer within a business unit 4 or graphic design firm 16 can create custom graphics displaying, for example, corporate trademarks for use on labels. A packaging engineer may use label management system 12 to create label templates and define labeling strategies for various “packaging levels” of a product. As referred to herein, packaging levels describe the packaging process that a product undergoes from the time the product comes off the manufacturing line to shipment. Designating a label as packaging level 1 may, for example, indicate that the label is to be placed directly on the product itself. Designating the label as packaging level 3 may indicate that the label is to be placed on a carton holding 10 individual products. Designating the label as packaging level 6 may indicate that the label is to be placed on a case packed with 12 cartons. Finally, designating the template as packaging level 8 may indicate that the label is to be placed on a crate shipped with 200 cases. A plant operator within manufacturing facility 6A may interact with label management system 12 to retrieve label data and generate appropriate labels for a given product based on the packaging level. In addition, a service representative within print center 14 may carry out high-volume print runs of labels based on label data retrieved from label management system 12.

Each user typically interacts with a computing device suitable for communication and interaction with label management system 12 via network 9. For example, a user may use a workstation, personal computer, laptop computer, or even a personal digital assistant (PDA) such as a Palm™ organizer from Palm Inc. of Santa Clara, Calif. or Windows CE device. The communication device executes communication software, typically a web browser such as Internet Explorer™ from Microsoft Corporation of Redmond, Wash., in order to communicate with label management system 12. Network 9 represents any communication link suitable for communicating data, such as a wide-area network, local area network or a global computer network like the World Wide Web.

By interacting with label management system 12, business units 4 can develop a common label management process for manufacturing sites 6 and, therefore, eliminate redundancies and inefficiencies inherent to a decentralized process. The business units 4 may, for example, develop and manage standardized graphics, allowing the company to provide more consistency and accuracy in the appearance of labeling entering distribution channels and customer markets. As described below, business units 6 can control and manage labels used for packaging, including the various sizes, layouts, formats, as well as the output mediums on which the labels are printed. This allows the corporation to better control the labels being presented to market on shipped products. In particular, multiple output locations, such as manufacturing facilities 6 and print center 14, and multiple output devices within a location, receive the same labeling data and, therefore, can print identical labels and other print material for packages and manufactured products. Accordingly, by providing access to a central label management system 12, label changes can be propagated universally and instantly throughout an organization.

One advantage of label management system 12 is the ability to support relocation of products from one manufacturing facility 6 to another. In other words, because label management system 12 centrally manages labeling data, business unit 4A, for example, can relocate products from manufacturing facility 6A to manufacturing facility 6B without needing to transfer labeling information, such as one or more digital files necessary to render a label. This process may be difficult with conventional desktop graphic design and label creation tools that typically execute on standalone workstations.

Another feature of label management system 12, as described below, is incorporation of revision control modules for developing and maintaining labeling data. Label management system 12, for example, includes revision control modules for controlling labeling data through all stages of the process including developing the label, approving the label for use by manufacturing facilities 6 and print center 14, and archiving and time stamping the label for subsequent verification. Label management system 12 supports, for example, check-in and check-out procedures for controlling access to label templates, graphics, and label data generally. Furthermore, these features of label management system 12 may be useful in tracking changes to labels and providing revision histories and other modification information.

Label management system 12 support and facilitates “on-demand” print systems by streamlining the delivery of label data to such systems when needed. In other words, label data can be quickly distributed to print systems when a company decides to manufacture a product, thereby allowing the company to satisfy any “just-in-time” manufacturing and supply contracts and other business relationships the company may service.

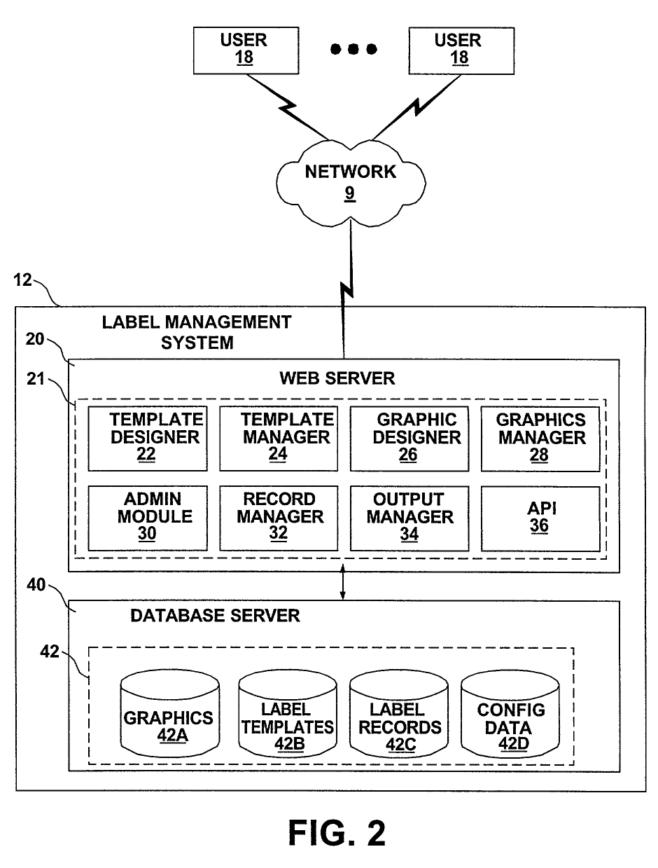

FIG. 2 is a block diagram illustrating label management system 12 in further detail. Web servers 20 provide an interface by which users 18 communicate with label management system 12 via network 9. In one configuration, web servers 20 execute web server software, such as Internet Information Server™ from Microsoft Corporation, of Redmond, Wash. As such, web servers 20 provide an environment for interacting with users 18 according to software modules 21, which can include Active Server Pages, web pages written in hypertext markup language (HTML) or dynamic HTML, Active X modules, Lotus scripts, Java scripts, Java Applets, Distributed Component Object Modules (DCOM) and the like.

Although illustrated as “server side” software modules executing within an operating environment provided by web server 20, software modules 21 could readily be implemented as “client-side” software modules executing on computing devices used by users 18. Software modules 21 could, for example, be implemented as Active X modules executed by a web browser executing on the computing devices.

Software modules 21 may include a number of modules including template design tool 22, template manager 24, graphic design tool 26, graphic manager 28, administration (Admin) module 30, record manager 32, output manager 34 and application programming interface (API) 36. Software modules 21 interact with data server 40 to access a number of data stores 42, including graphics 42A, templates 42B, label records 42C and configuration (config) data 42D. Each data store 42 may be implemented in a number of different forms including a data storage file, or one or more database management systems (DBMS) executing on one or more database servers. The database management systems may be a relational (RDBMS), hierarchical (HDBMS), multidimensional (MDBMS), object oriented (ODBMS or OODBMS) or object relational (ORDBMS) database management system. Furthermore, although illustrated separately, data stores 42 could be combined into a single database or other data storage structure. Data stores 42 could, for example, be implemented as a single relational database such as SQL Server from Microsoft Corporation.

Graphics 42A include corporate graphics, such as trademarks, logos and other imagery, for printing on labels. Graphics 42A may be stored as, for example, individual image files stored in any of a number of formats including JPEG, TIFF, GIFF, PDF and the like. Templates 42B stores templates for creating labels and typically describes a layout, format and a number of fields. Label records 42C store label data for a number of labels generated by users 18 from label templates 42B. Configuration data 42D stores configuration data including, for example, authorized users 18, user and corporate preferences, preferred output stock (substrates) for labels, and available printers. In addition, configuration data 42D includes data defining business units 4, manufacturing sites 6, and the various packaging levels used during the manufacturing process.

Template design tool 22 provides online label design and layout functionality for creating label templates. In other words, template design tool 22 presents a graphical user interface by which users 18 can construct templates. During this process, a user 18 typically defines the size and layout for a template, as well as defining a number of fields for capturing label data, possibly at print time. Although illustrated and described as an online, web-based template design tool, template design tool 22 may comprise a conventional label design software, such as CodeSof™ and LabelView™ from Teklynx™, and may run on independent computing devices.

Upon creating a label template, a user 18 interacts with template manager 24 to “check-in” the template into label management system 12. During this process, template manager 24 parses the data generated by template designer 22, typically a text file with embedded codes defining a number of fields, and stores the parsed data within templates 42B. During the check-in process, the user provides all information necessary for categorizing the template including, for example, a name for the label template, appropriate business units 4 that may use the template, markets for which the label may be applicable, a “trustee” for the template, and the corresponding packaging level(s) for which the template applies. After describing the template, the user uploads the file produced by template design tool 22 to label management system 12, which stores the file in templates 42B.

Similarly, graphic design tool 26 provides a web-based design tool for creating graphics such as corporate trademarks, logos, and the like. In other words, graphic design tool 26 presents a graphical user interface by which users 18 can construct images.

Alternatively, uses 18 may use a conventional graphic design software, such as Adobe Photoshop™ from Adobe System Incorporated or Corel Draw™ from Corel, Inc.

After creating graphics for corporate labels, a user 18 interacts with graphic manager 28 to check-in the graphics into label management system 12. During the process, the user 18 typically uploads the graphic file, such as a JPEG, GIF, TIFF or PDF file, to label management system 12, which stores the file in graphics data store 42A.

Administration (admin) module 30 present an interface by which authorized users, such as system administrators, configure label management system 12. A system administrator may, for example, manage accounts for users 18 including setting access privileges, and define a number of corporate and user preferences. Examples of corporate preferences include preferred language translations, signature lines, suggested label stock. Examples of user preferences include authorized printers for each user, as well user access rights to modules 21. Admin module 30 allows the system administrator to define access rights for users 18 to control the access to the various software modules 21. In this manner, not all users can access all of the software modules 21. For example, a graphic designer may have access rights to graphic designer software module 26 and graphics manager 28, while a plant operator may only have access rights for the output manager 34.

In addition, a system administrator can interact with admin module 30 the administrator can define logical categories and hierarchies for characterizing and describing labels used for packaging and manufacturing. The system administrator may define, for example, categories such as markets, business units and a hierarchy of packaging levels, such as levels one through eight. In addition, the system administrator may define a number of label fields supported by label management system 12.

Record manager 32 allows users 18 to define labels for use on packaging and manufactured products, based on label templates 42B, graphics 42A and config data 42D. In other words, users 18 interact with record manager 32 to create new labels based on templates, and populate the fields of the templates with text, graphics or other data. Furthermore, record manager 23 allows a user to set various characteristics and properties for the defined fields for a label. A user may, for example, enable “dynamic scaling” for a text or graphic element field, causing label management system 12 to dynamically select a font size for corresponding text or dynamically scale the graphic element, so that the text or graphic element can be fully displayed within the label field.

Record manager 32 integrates formal control modules and procedures to manage the process of developing and maintaining label records 42C. Record manager 32, for example, includes revision control modules for controlling the development of label records 42C from creation to approval and archival. Record manager 32 supports, for example, check-in and check-out mechanisms for controlling access to label records and tracks modifications to the records to provide revision histories and other modification information. Each label record has a corresponding status, such as draft, pending, approved, archived, obsolete and superceded.

Once a user 18 changes a status for a label record from “draft” to “approved,” record manager 34 generates an electronic image of the label, such as a PDF (portable document format) output, timestamps the image and archives the image. A version of the image may be stored as a low resolution “thumbnail” to facilitate ready identification by users without the need to retrieve the entire high-resolution image. Record manager 32 associates data from the corresponding label record with the archived label image to allow for indexing and quick retrieval.

Output manager 34 controls all aspects of label printing. Once a user 18 has created a template and entered the template into label management system, created a corresponding record for the template and populated the fields of the template, output manager 34 makes the label available for printing at manufacturing facilities 6 or print center 14. Only records having an approved status are “published” to manufacturing facilities 6, i.e., are available to user 18 via the output manager 34. This gives business units 4 the ability to manage data, add new labels, update labels without concern about the possibility that one of manufacturing sites 6 may prematurely use an unapproved label. As described below, run-time fields can be added to the template during design, which causes output manager 34 to prompt for the information at the time of print. Examples of run-time information include batch code, lot code, manufacture date, serial numbers and the like. In one embodiment, label management system stores the run-time data as labels are printed for tracking and tracing purposes.

Application programming interface (API) 36 provides the ability to establish direct connections with external computing devices, allowing such devices to automatically control label management system 12. A front-end module, such as a script or command line interface provided by the remote computing device, for example, may communicate with API 36 directly, bypassing the interfaces presented by other software modules 21. In this manner, the front-end module can automatically interact with label management system 12 and control output. As a result, API 36 can be useful when connecting to internal corporate systems to incorporate, for example, product information. In addition, API 36 may be used at manufacturing time to automatically provide run-time information for labels and other printed materials.

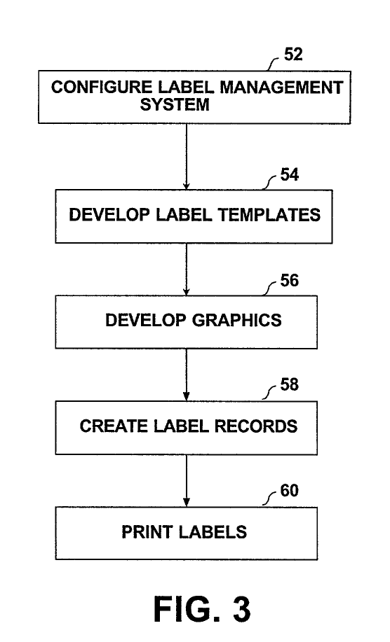

FIG. 3 is a flow chart illustrating central management of labeling data for packaging and manufactured products according to the invention. Initially, an authorized user, such as a system administrator interacts with admin module 30 to configure label management system 12 setting up user accounts, defining preferences, access rights, and logical categories such as markets, business units and packaging levels (52).

Next, authorized users of business units 4 (FIG. 1) interact with template design tool 22 and template manager 24 to develop and manage label templates (54). Similarly, authorized users of business units 4 interact with graphic design tool 26 and graphic manager 28 to develop and manage corporate approved graphics for printing on the labels (56). Authorized users of business units 4 then interact with record manager 32 to create label records based on the templates, and populate the fields of the templates with text, graphics or other data (58). Remote manufacturing facilities 6, print centers 14 or other output locations interact with output manager 34 to retrieve and print approved labels for packaging and manufactured products (60).

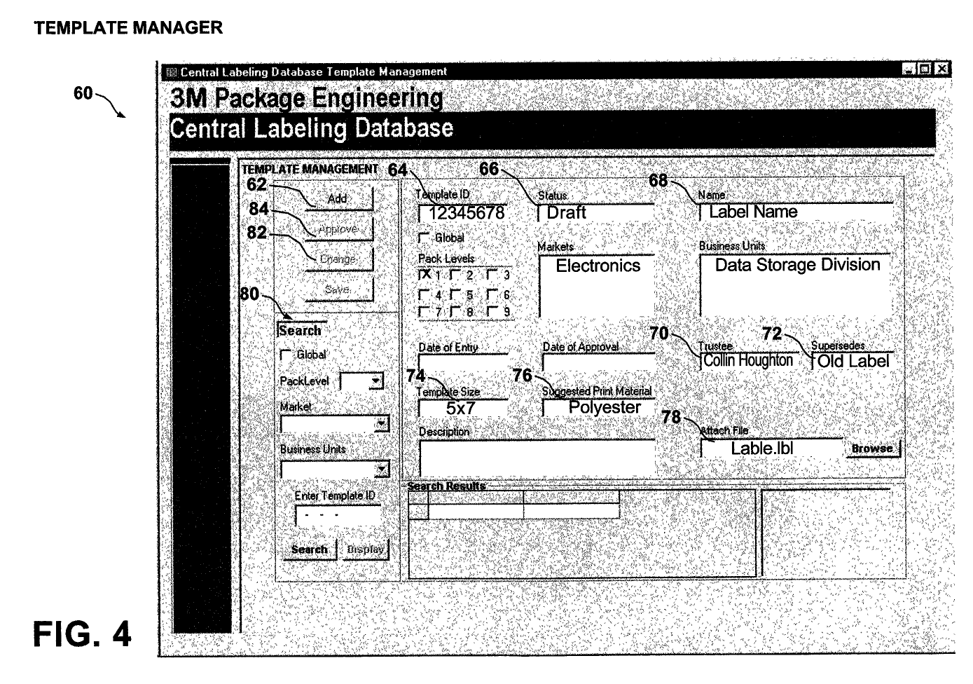

FIG. 4 illustrates an example web-based user interface 60 presented by template manager 24. An authorized user can check-in templates to label management system 12 by clicking on the Add button 62, at which time label management system 12 automatically assigns a unique template ID 64 and initializes a publication status 66 to “Draft.” At this time, the user can assign a template name 68.

Interface 60 provided by template manager 24 supports the logical categories defined by the corporation for managing templates throughout business units 4. When adding a new template, for example, the user may mark the template as global to make the template available throughout the company. Alternatively, the user may specify a packaging level, business unit and market for the template. The trustee 70 indicates the user that has authority to modify the template being checked-in, typically the user that created the template using graphic design tool 22.

Often, a template may supersede an older template, as identified by window 72. Template size 74, such as 5×7, indicates the physical size of the template when printed. All of the parameters and attributes captured by template manager 24 will be stored in label management system 12 and be available later to the user via other software modules 21, including record manager 32 and output manager 34. The user can suggest print material for the label within window 76. When printing the label, as described below, the output manager displays the suggested print material to aid the operator. Finally, the user can attach a template file produced by the template designer 22 by entering a filename within window 78.

Search window 80 allows the user to locate one of stored label template 42B instead of creating a new template. After finding a template, the user can modify the parameters and select change button 82. After finalizing the template, the user can “approve” the template by selecting the approve button 84, thereby marking the template as available for use.

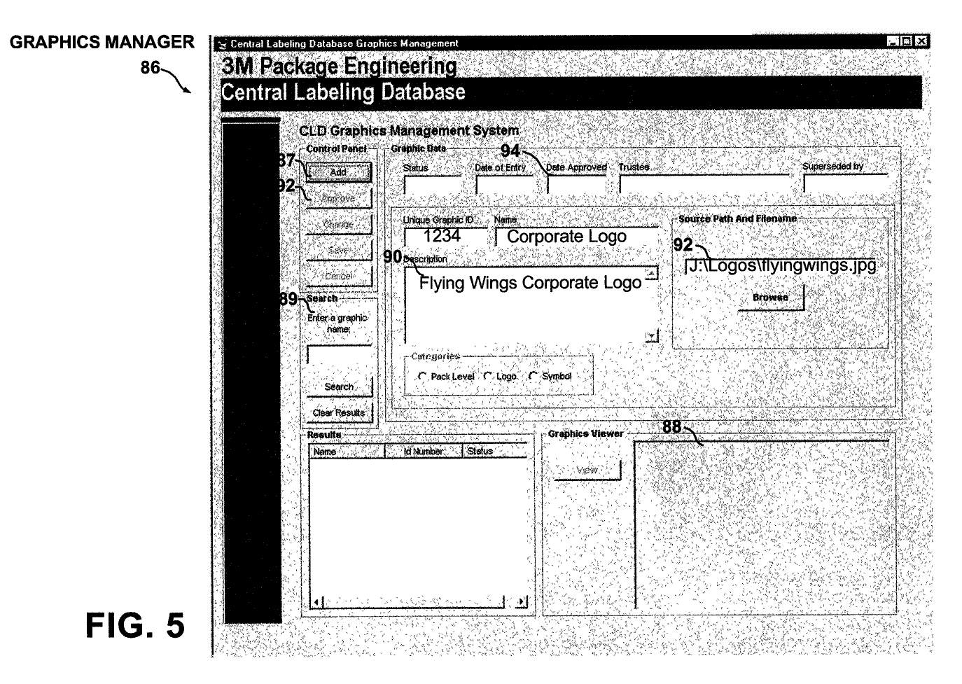

FIG. 5 illustrates an example web-based user interface 87 presented by graphics manager 28. An authorized user can check-in graphics to label management system 12 by clicking on the Add button 86 after completing the various fields presented by interface 86, at which time label management system 12 automatically assigns a unique graphic ID and initializes a status for the graphic to “Draft.” Typically, the user assigns a graphic name 89, provides a short description 90 and provides a location 92 where the graphic file is located.

After checking in the graphic, the user can modify the data describing the graphic, or update the image itself. Interface 86 provides viewer 88 by which the user can preview the image during the check-in and modification process. Upon approving the graphic, by selecting the Approve button 92, graphic manager 28 changes the status to approved and records the date approved 94.

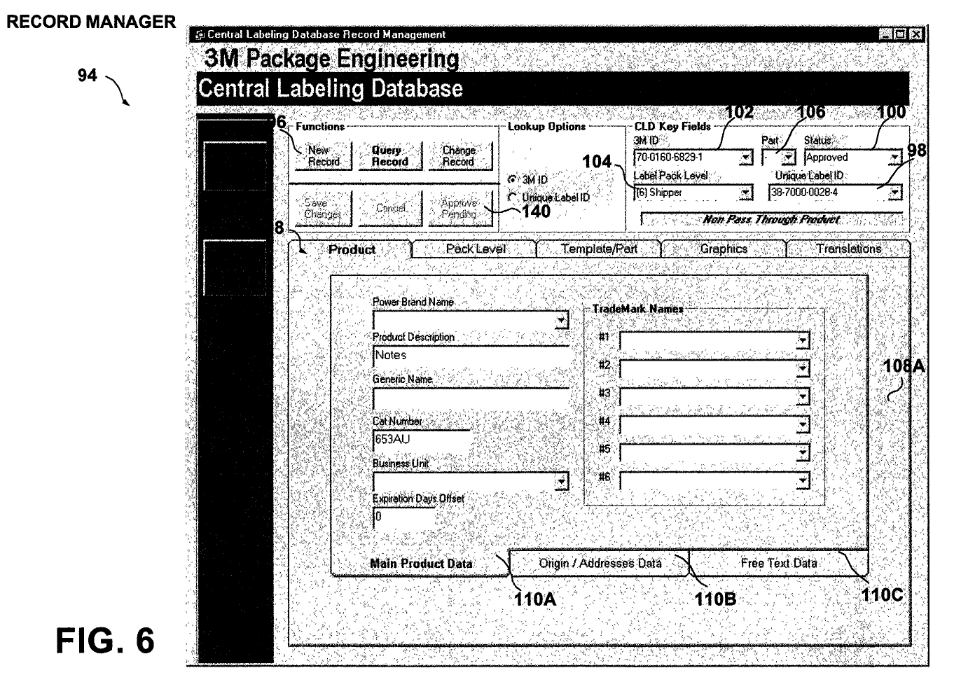

FIGS. 6-11 illustrate an example web-based user interface 94 presented by record manager 32. Generally, interface 94 allows users to define labels for use on packaging and manufactured products using on label templates and graphics uploaded to label management system 12 by template manager 22 and graphics manager 28, respectively. Referring to FIG. 6, users interact with interface 94 presented by record manager 32 to provide data for the fields of a selected template. The user may, for example, associate a field with text, graphics or other data.

To create a label record, a user having rights to access record manager 32 selects New Record button 96 at which time label management system 12 automatically assigns a unique label ID 98 and initializes a status 100 for the record to “Draft.” The unique label ID is useful for compliance with regulations, such as the regulations found in the health care and pharmaceutical industries that require a labeling change management process, for example utilizing a single, unique control number for each label.

The user may also select a pre-existing label record and make changes. Interface 94 offers two mechanisms for selecting a record. The user may traverse the logical categories defined for label management system 12 by providing, for example, a corporate label ID 102, a packaging level 104, and a corresponding manufactured part or product 106. For a given corporate ID number 102, there may be a number of records covering the various packaging levels. These records form a related family that can share common data, such as a message or warning text that must be displayed on labels for all packaging levels. The second method for finding a label is to supply the unique label ID 98.

In another embodiment, record manager 32 displays a number of graphic thumbnails from which the user selects a desired label template. Record manager 32 then graphically displays graphics associated with the selected label template and overlays the corresponding fields.

When creating a label record, label management system 12 allows the users to control when manufacturing facilities 6 use an updated label. This may be useful in heavily regulated industries where the manufacturing company may need to record the specific point where labels change, such as in the medical and pharmaceutical industries. In particular, the user can classify the record as “pass through” or as “non-pass through.” The output manager 34 uses an updated label immediately if the label is designated as “pass through.” Once a user has approved a pass through label record, the old record is immediately replaced and an image of the label for the old record is archived in a graphic format, such as PDF, to create a permanent record of the old label.

For non-pass through labels, output manager 34 allows the manufacturing facilities 6 to control when the updated label record is used in place of the superceded label record. This allows the manufacturing facilities 6 to print the older labels for a desired period of time, such as until the end of a batch run or the depletion of current inventory. During this process, label management system 12 automatically maintains a duplicate label record within label records 42C controlled by the corporate ID number. Manufacturing facilities 6 can elect when to replace the old record with the updated one.

Interface 94 provides a number of data entry windows 108 for mapping information, such as text and graphics, to corresponding fields within the selected label template. In other words, data entry windows 108 present the logical elements of information that may exist on approved corporate packaging labels, and are initially defined by a system administrator or other authorized user. In one embodiment, interface 94 displays only the fields that exist on the selected template. In this embodiment, record manager 32 determines the defined fields for the corresponding label template and presents those fields within data entry windows 108. Data entry windows 108 may require that the input from the user match constraints defined within template manager 24 during template creation. In this manner, the template may control the number of characters and format for each field.

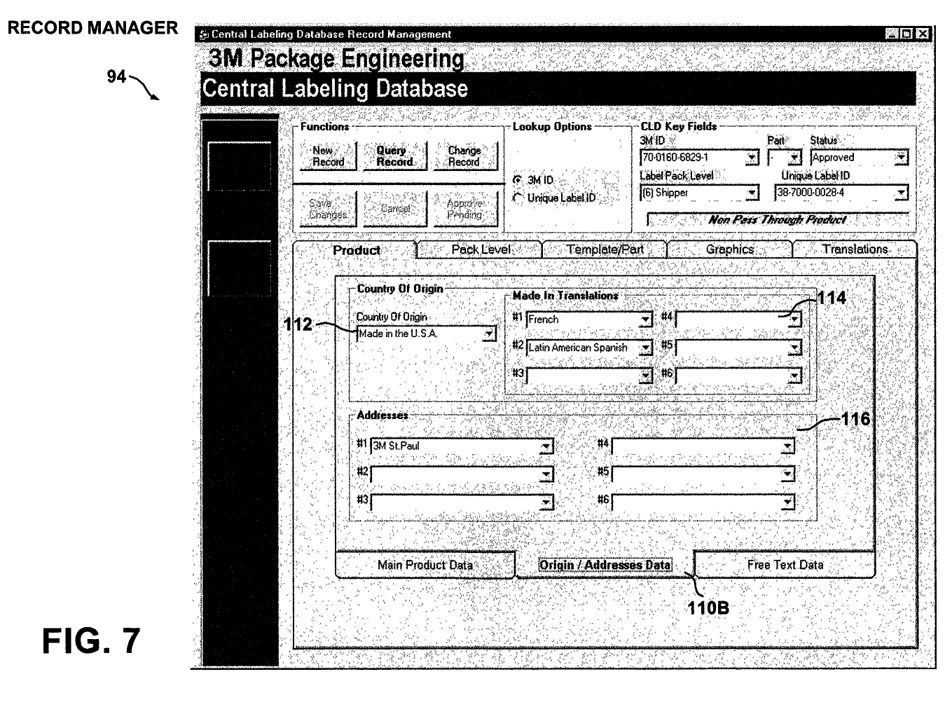

Product data entry window 108A captures product specific data for the selected label record and includes three windows including main product data entry window 110A, origin-address data entry window 110B and free text data entry window 110C. As illustrated in FIG. 7, origin-address data entry window 110B allows a user to specify a country of origin 112 for the product, translations 114 that are available for the label, and an address 116 of the manufacturer. Free text data allows the user to add miscellaneous messages such as “50% off” or “Buy one get one free” to a label.

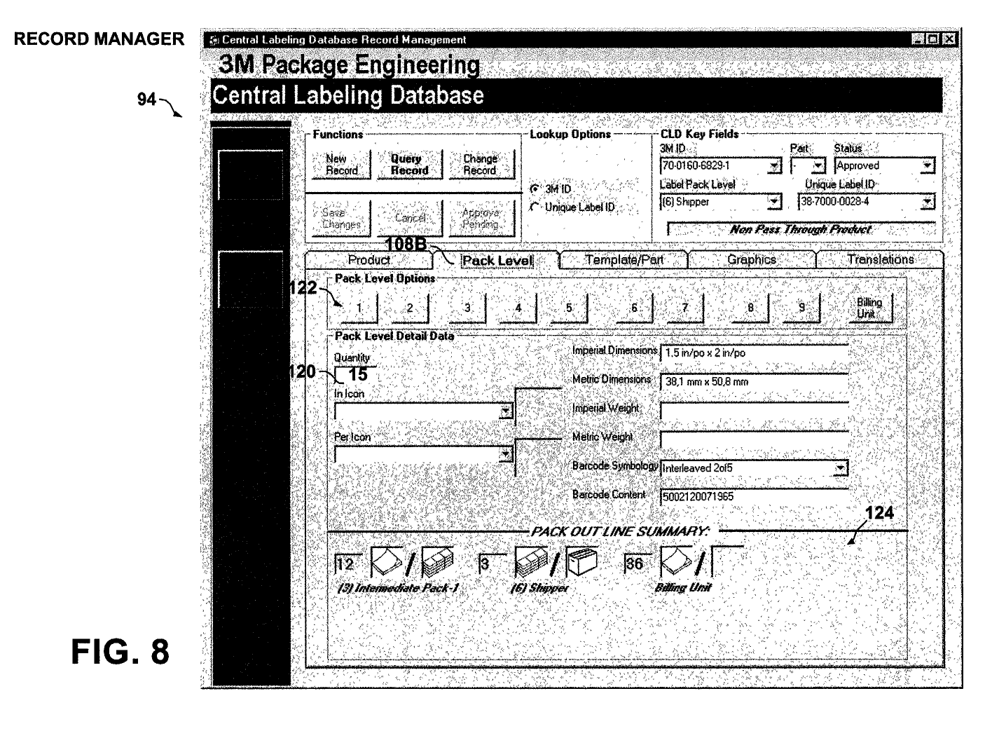

FIG. 8 illustrates packaging level data entry window 108B of user interface 94. Packaging level data entry window 108B allows the user to identify the packaging levels for a manufacturing product. In particular, the user can define the quantity 120 of the product within each of packaging levels 122, and define various features, such as size and weight, at each level. In addition, the user may select graphical icons representing the components and container for each packaging level. Window 124 graphically illustrates the packaging process.

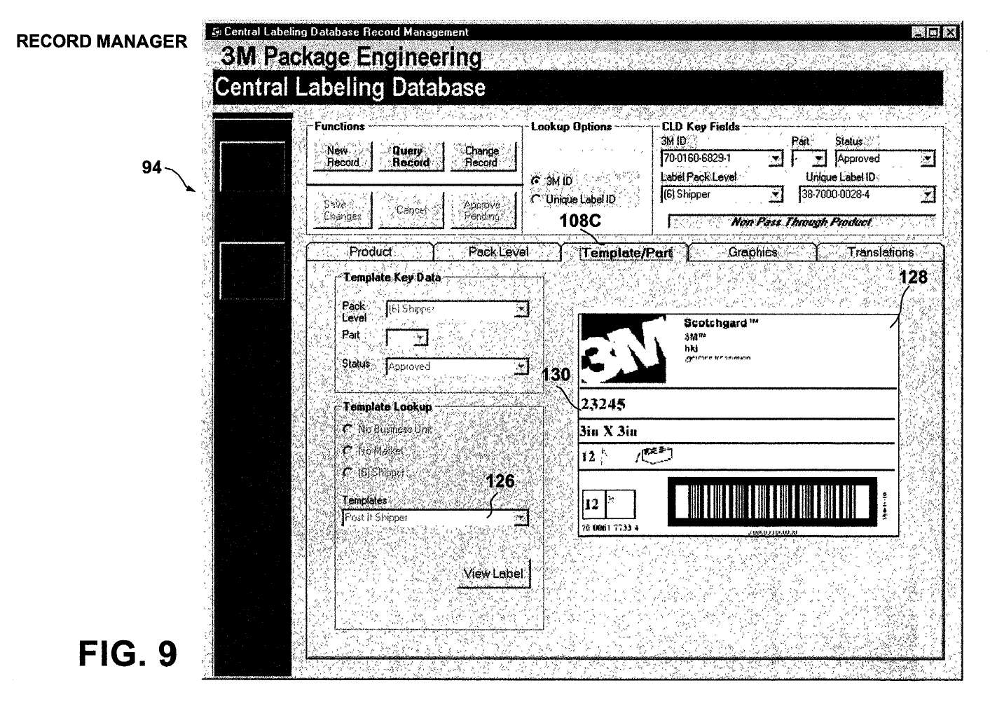

FIG. 9 illustrates template-part data entry window 108C of user interface 94. Template-part data entry window 108C allows the user to identify the corresponding template 126 for the current label record, and displays an image 128 that graphically illustrates the label as well as the corresponding fields 130 associated with the label.

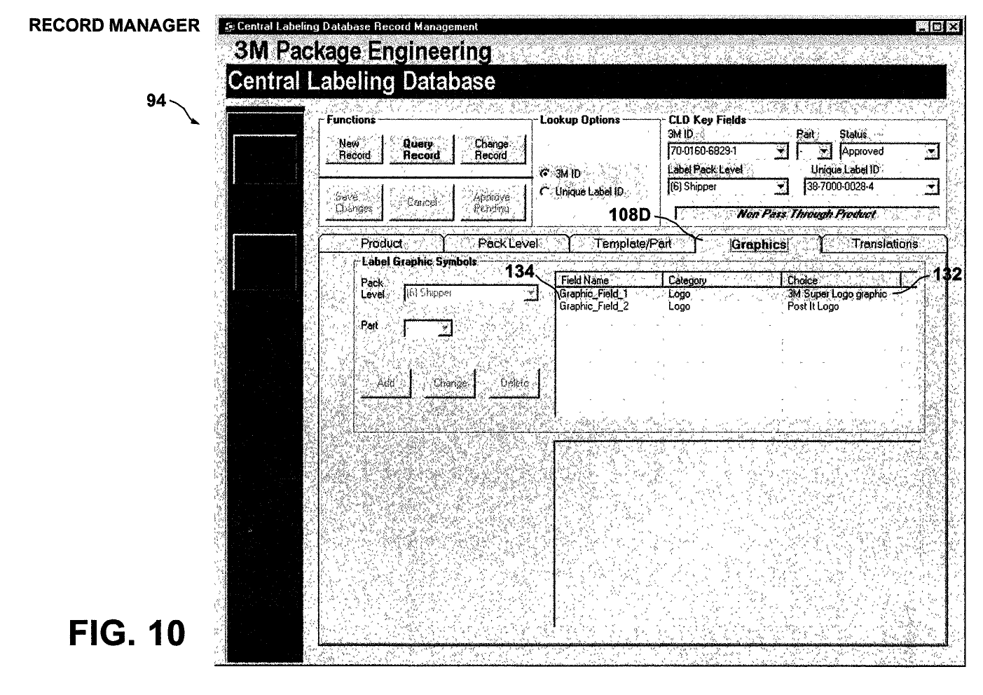

FIG. 10 illustrates graphics data entry window 108D of user interface 94 that allows the user to assign graphics 132 for the various fields 134 within the template. Graphics 132 can be can be any type of format including BITMAP, JPEG, TIFF, GIFF, EPS, and the like.

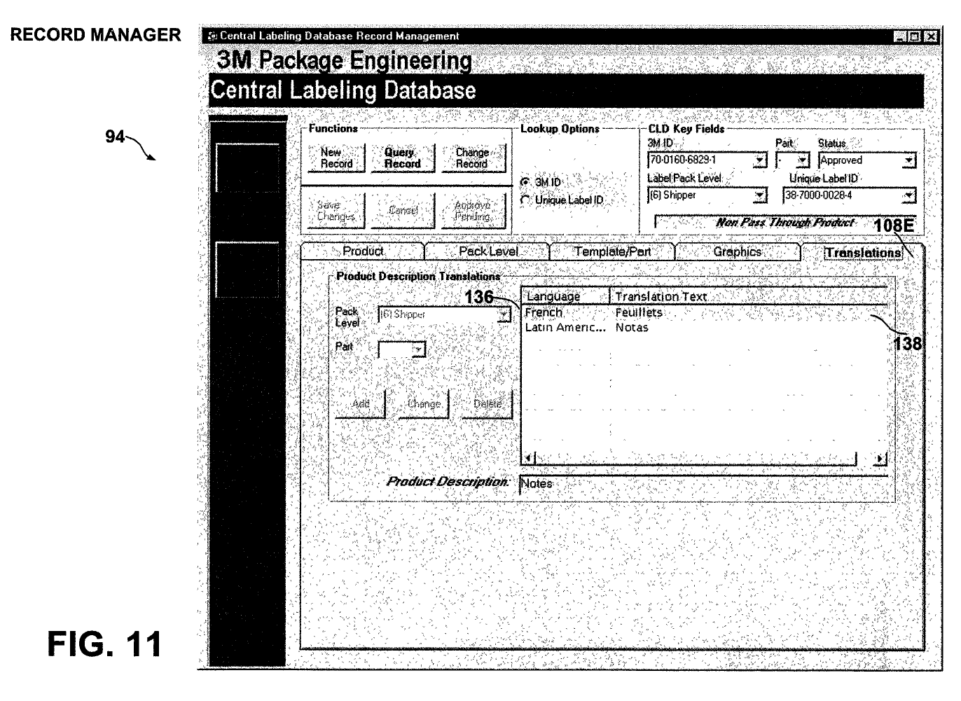

FIG. 11 illustrates translations data entry window 108E of user interface 94 that allows the user to select one or more languages 136 for the label and enter translation text 138 for one or more fields. In this manner, any text on the label can be multilingual. In one embodiment, label management system 12 is Unicode compliant and can readily support a wide variety of character sets.

Referring again to FIG. 6, once the user has completed the data entry process, the user can approve the label by selecting Approve button 140. Upon approval, record manager 32 generates an image, such as a PDF file, of the resultant label based on the graphics and other data associated with the fields of the selected label. In addition, record manager 32 timestamps the image and archives the image to record a visual representation of the exact label that is available for use by manufacturing facilities 6. Label management system 12 associates data from the current record with the archived image to allow for indexing and quick retrieval.

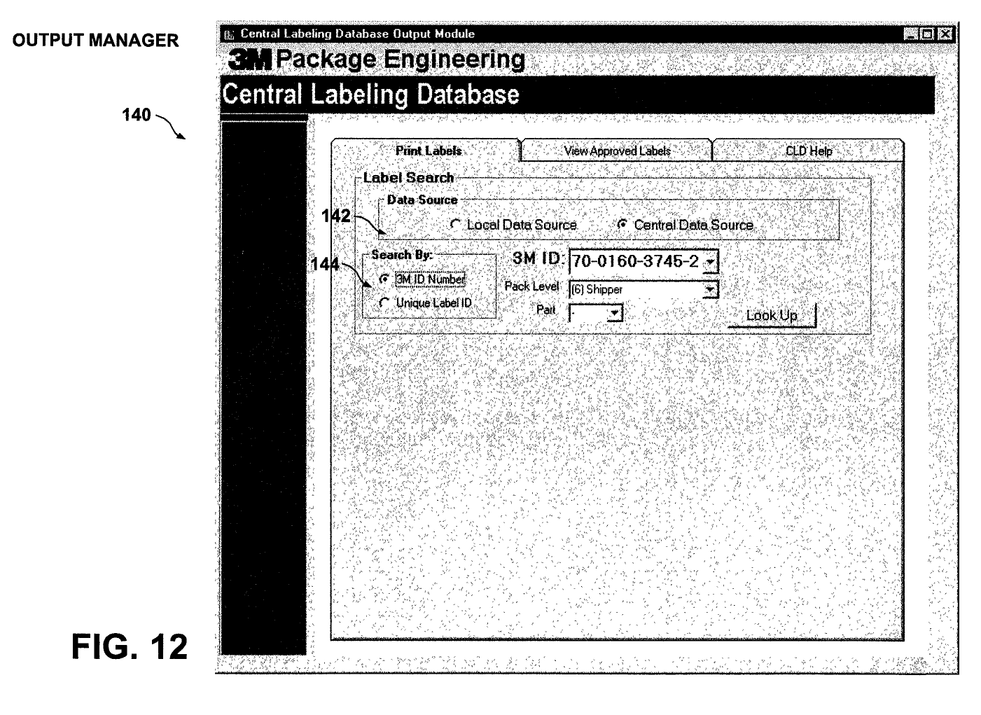

FIGS. 12-14 illustrate an example web-based user interface 140 presented by output manager 34. Generally, interface 140 controls all aspects of label printing by manufacturing facilities 6. Referring to FIG. 12, a user, such as a plant operator within one of manufacturing facilities 6, first interacts with data source selection window 142 to elect whether to retrieve label data from label management system 12 via network 9, or from a local copy of data stores 42. This option is useful to maintain manufacturing even in situation where network 9 is unavailable. Specifically, label management system 12 may replicate data stores 42, or portions thereof, to local servers within each manufacturing facility 6 and print center 14.

After selecting the data source, the user then selects a desired label record using search window 144. In particular, the user can enter a unique label ID, or a corporate ID and corresponding packaging level and part. Only label records having an approved status are available to the user via output manager 34. This gives business unit 4 the ability to manage label data, create new labels, and update labels without worrying about the manufacturing facilities 6 prematurely using non-approved labels.

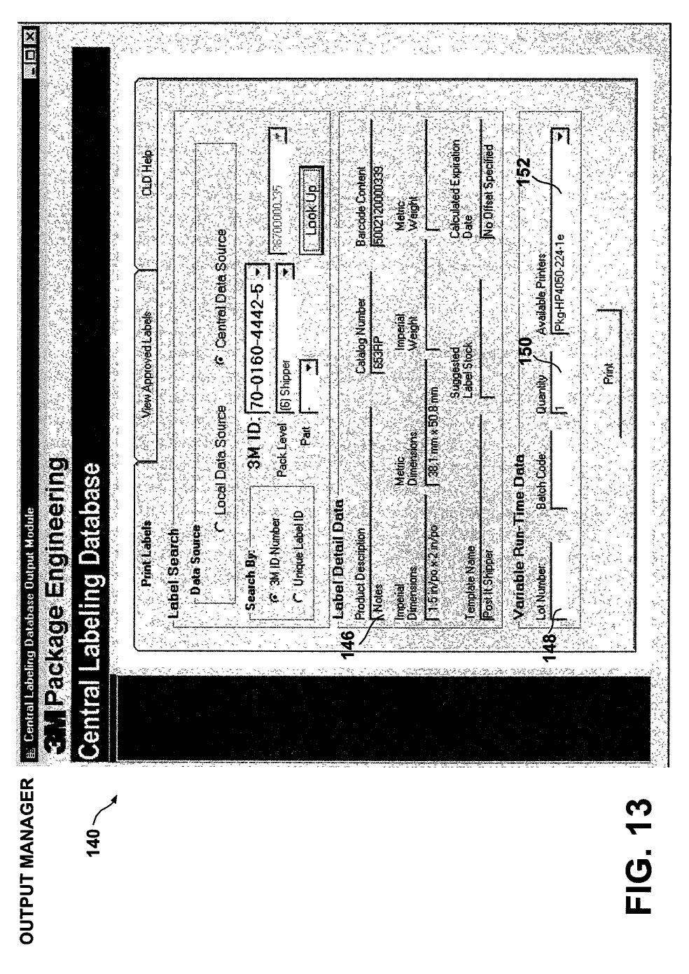

As illustrated in FIG. 13, once a label is identified, output manager 34 retrieves the detailed data for the label from label records 42C and displays the data within window 146. Interface 140 displays this information in non-editable form for verification by the user. In addition, interface 140 displays any run-time fields 148, such as fields 150 and 152, for capturing data as, for example, lot number and batch code. Next, the plant operator selects a quantity 150 and an available printer 152. As described above, output manager 34 controls the list of available printers 152 based on access settings within config data 42D.

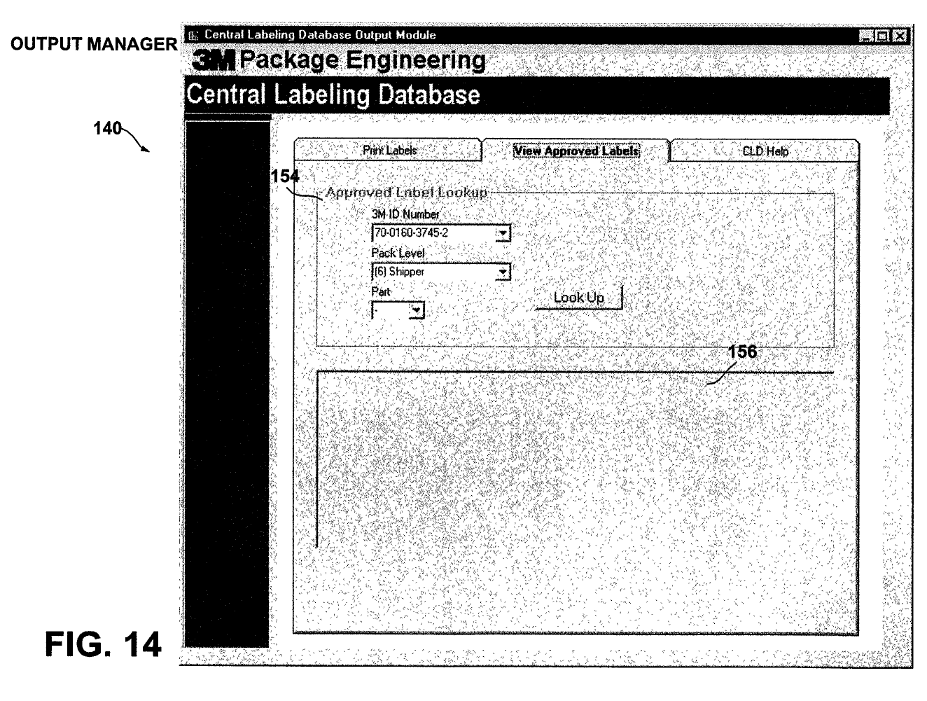

As illustrated in FIG. 14, viewing approved labels window 154 of output manager 34 provides the ability to verify a printed label in comparison with the approved label as archived by record manager 32. More specifically, the user may typically print a single label and compare the printed label against the archived image displayed in view screen 156. Verification against the archived label is more accurate than performing a print preview, as commonly available in conventional systems. A print preview only displays the label that is about to be printed, versus displaying the exact approved version. This feature may be particularly useful for regulated industries. Upon verifying the label, the user select a print mode and quantity, and print either individually, continuously, or a combination thereof Alternatively, the user may store the generated labels to a computer-readable file in a variety of formats, such as EPS or bitmap. The user may then ship the generated label to a high-end print service for printing large volume batches.

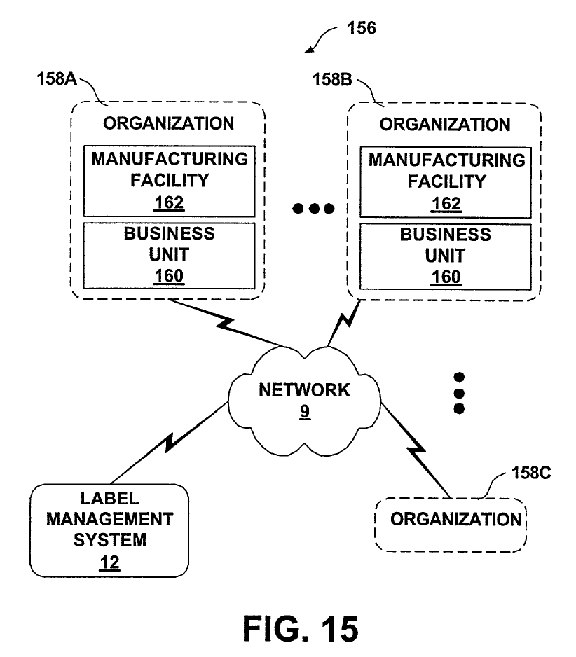

FIG. 15 is a block diagram illustrating a system 156 in which label management system 12 hosts labeling data for a plurality of organizations 158A through 158C, collectively referred to as organizations 158, thereby allowing organizations 158 to centrally manage labeling data for packaging and manufactured products generally. Each of organizations 158 may include one or more business units 160 that interact with label management system 12 via network 9 to develop and manage the packaging labels or other printed material for manufactured products. Each organization 158 may also include remote manufacturing facilities 162, print centers or other output locations that interact with label management system 12 via network 9 to retrieve label data for company approved labels when manufacturing products. In addition, an entity 158, such as entity 158C, may not have separate business units 160 or manufacturing facilities 162, but may manage and output label data from a small number of locations, or even a single workstation and printer.

In this configuration, label management system 12 organizes label data within data stores 42 based upon the associated entity 158. In other words, all templates, users, graphics, records and other label data is related to one of organizations 158, and is not accessible by the other organizations 158.

In this manner, label management system 12 may support organizations 158 of all sizes ranging from sole proprietorships to large corporations. Label management system 12 may charge business organizations 158 fees in a number of ways. Label management system 12 may, for example, charge organizations 158 data warehouse fees based on the number of label records, templates and graphics, or any combination thereof, stored by each of business organizations 158. Label management system may also charge fees based on the number of accesses by users within organizations 158. In addition, label management system 12 may charge subscription service fees or fees based on the number of labels printed.

Alternatively, label management system 12 may be offered as a value-add service coupled with other services or packaging materials. For example, services provided by label management system 12 may be offered to entities 158 in conjunction with the sale of packaging material, such as packaging tape.

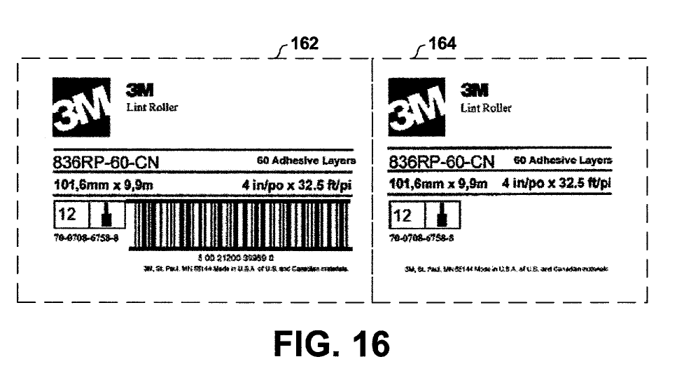

FIG. 16 illustrates two example labels 162, 164 produced by output manager 34 at an output location such as one of manufacturing facilities 6. Each label 162, 164 includes a variety of text and graphics associated with fields of a respective label template by a corresponding label record.

Various implementations and embodiments of the invention have been described. For instance, a label management system for developing and managing packaging labels or other printed material for manufactured products has been described. The components of the system may be implemented as server-side components, client-side components, or a combination thereof. Nevertheless, it is understood that various modifications can be made without departing from the invention. Accordingly, these and other embodiments are within the scope of the following claims.

1. A system comprising:
a database storing label records and associated label data for a plurality of different products manufactured by an organization;
a label record manager that controls the creation and modification of the label records by multiple users within the organization, wherein the label record manager includes a revision control module to track changes made to the label records and the associated label data; and
an output manager that receives input from the multiple users and permits the users to selectively access the label records for printing on label media to be affixed to the different products.

2. The system of claim 1, wherein the revision control module of the label record manager maintains modification logs for the label records and provides change histories for the label records.

3. The system of claim 1, wherein the revision control module of the label record manager generates images of labels from the label records and associated label data, and archives the images with corresponding date and time stamps.

4. The system of claim 1, wherein the revision control module of the label record manager presents an interface by which a user can check-in and check-out a label record for revision.

5. The system of claim 1, wherein the database further stores reusable label templates that define one or more fields, and the system further comprises a template manager software module that presents an interface for managing the label templates stored by the database.

6. The system of claim 5, wherein the template manager includes a revision control module to track changes made to the label records

7. A method comprising:
storing label records and associated label data;
generating images of labels based on the label records and associated label data; and
archiving the images with corresponding date and time stamps.

8. The method of claim 8, further comprising recording changes to the label records in a database.

9. The method of claim 7, further comprising displaying change histories for the label records based on the recorded changes.

10. The method of claim 7, further comprising presenting an interface by which a user can check-in and check-out a label record.

11. A computer-readable medium comprising instructions for causing a programmable processor to:
store label records and associated label data; and
generate images of labels based on the label records and associated label data; and
archive the images with corresponding date and time stamps.

12. The computer-readable medium of claim 11, further comprising instructions for causing the processor to:
present an interface by which a user can check-in and check-out a label record; and
record changes to the label records in a database.

13. A system comprising:
a database storing a label record having a publication status;
a label record manager that presents an interface for maintaining the label record and setting the publication status of the label record; and
an output manager for printing a label at one of a plurality of output locations based the label record and the publication status.

14. The system of claim 13, wherein the label record manager presents an interface by which a user can selectively change the publication status between a draft status and an approved status.

15. The system of claim 13, wherein the database includes configuration data defining the plurality of output locations and a plurality of groups of an organization, and wherein the database associates the label record with one of the groups of the organization.

16. The system of claim 13, wherein the plurality of groups comprising a plurality of business units, and the plurality of output locations comprise manufacturing facilities.

17. The system of claim 13, wherein the label record manager includes revision control modules.

18. A method comprising:
storing a label record having a publication status;
presenting an interface for setting the publication status of the label record; and
printing a label at one of a plurality of output locations based on the label record and the publication status.

19. The method of claim 18, further comprising storing label templates and label data, wherein the label records associate the label data with fields of the label templates.

20. The method of claim 19, further comprising:
storing configuration data defining a plurality of groups within an organization; and
associating each label template with one of the groups.

21. A computer-readable medium comprising instructions for causing a programmable processor to:
store a label record having a publication status;
present an interface for setting the publication status of the label record; and
print a label at one of a plurality of output locations based on the label record and the publication status.

22. The computer-readable medium of claim 21, wherein the instructions cause the processor to store label templates and label data, wherein the label records associate the label data with fields of the label templates.

23. The computer-readable medium of claim 19, wherein the instructions cause the processor to:
store configuration data defining a plurality of groups within an organization; and
associating each label template with one of the groups.

24. A label management software system comprising a database storing configuration data defining an organization having a number of business units and manufacturing facilities, wherein the label management system creates a label record associated with one of the business units, and selectively prints a label at one of the manufacturing facilities based on the label record and the associated business units.

25. The system of claim 24, wherein the database stores configuration data defining a number of packaging levels, and further wherein the label record designates at least one of the packaging levels.

26. The label management system of claim 24, wherein the label management system further comprises:
a label record manager to create the label record from a label template and label data; and
an output manager to control the printing of the label upon authorizing a user having access rights to print the label.

27. A method comprising:
storing configuration data defining a number of business units and manufacturing facilities;
storing label records and corresponding label data;
associating the label records with the business units;
selecting one of the label records; and
printing a label at one of the manufacturing facilities according to the selected label record and the associated business unit.

28. The method of claim 27, further comprising:
storing configuration data defining a number of packaging levels; and
associating each label record with a packaging level.

29. The method of claim 27, further comprising associating a number of label records to form a set of related label records.

30. The method of claim 29, further comprising graphically illustrating the packaging levels associated with the set of related label records.

31. A system comprising:
a database storing label records and associated archived label images of labels; and
an output module to print a label from a selected one of the label records, wherein the output module includes an interface for presenting the archived label image associated with the selected label record.

32. The system of claim 31, wherein the database further stores reusable label templates that define one or more run-time fields, wherein the output manager displays the run-time fields when printing the label to prompt for the run-time information.

33. The system of claim 31, wherein the database is replicated from a central database to a local database located at a manufacturing facility, and further wherein the output module selectively accesses the central database and the local database.

34. A method comprising:
storing label records and associated archived images of labels;
selecting one of the label records;
displaying the archived label image associated with the selected label record for verification by a user; and
printing a label upon receiving input indicative of the verification.

35. The method of claim 34, further comprising:
storing label templates that define one or more run-time fields; and
displaying the run-time fields when printing the label to prompt the user for the run-time information.

36. The method of claim 35, wherein the run-time information includes at least a batch code and a lot code.

37. The method of claim 34, further comprising:
replicating the label records and associated archived images from a central database to a local database located at a manufacturing facility; and
and selectively retrieving the label records and associated archived images from the central database and the local database based on a user selection.

38. The method of claim 34, further comprising generating the archived images from the label records when a user sets a publication status for the label records.

39. A computer-readable medium comprising instructions for causing a processor to:
store label records and associated archived images of labels;
select one of the label records;
display the archived label image associated with the selected label record for verification by a user; and
print a label upon receiving input indicative of the verification.

40. The computer-readable medium of claim 39, further comprising instructions for causing the processor to:
store label templates that define one or more run-time fields; and
display the run-time fields when printing the label to prompt the user for the run-time, information.

41. A computer-readable medium containing data comprising:
a label template defining a number of fields, a packaging level and one or more associated business units;
label data including text and graphics;
a label record associating the label data with the fields of the label template; and
configuration data defining one or more remote output locations.

42. The computer-readable medium of claim 41, wherein the configuration data defines one or more manufacturing facilities.

43. The computer-readable medium of claim 41, further comprising a pass through flag controlling when the label record supercedes a second label record.

44. The computer-readable medium of claim 41, wherein the configuration data defines a number of users, and access control rights for the users.

45. A label management system comprising:
a database storing label templates and label records associating label data with the label templates;
a template design tool to create the label templates, wherein the template defines one or more fields;
a graphics design tool to create graphics;
a template manager software module to parse the templates and store for the templates and field information within the database;
a graphics manager to receive the graphics from the graphics design tool and store corresponding graphical data within the database;
a label record manager software module presenting an interface to create label records for associating the graphics and text within the fields of the label template; and
an output manager software module for printing a label based on a selected one of the label records and the associated graphics and text.

46. The label management system of claim 45, wherein the database stores configuration data defining a plurality of groups and a plurality of output locations for an organization, wherein the template manager presents an interface for associating the templates with the groups.

47. The system of claim 45, wherein the database is one of a relational (RDBMS), a hierarchical (HDBMS), a multidimensional (MDBMS), object oriented (ODBMS or OODBMS) or object relational (ORDBMS) database management system.

48. A label management software system comprising:
a database storing configuration data defining plurality of organizations, each organization having at least one group and at least one output location; and
a plurality of software modules executing on computing devices coupled to the database and presenting an interface by which each authorized users of the groups create label records, and selectively prints the labels at the corresponding output location for the organizations.

49. The label management system of claim 48, wherein the software modules calculate fees for each organization and record the fees within the database.

50. The label management system of claim 49, wherein the software modules calculate fees for the organizations based at least one of (a) a number of accesses by each organization, (b) a number of label records and label templates stored by each organization, and (c) a subscription fee.

51. A method of providing a label management service comprising:
storing configuration data defining plurality of organizations, each organization having at least one group and at least one output location;
presenting an interface for by which each authorized users of the groups create label records; and
in response to input from the users, selectively printing labels at the corresponding output locations for the organizations.

52. The method of claim 51, further comprising calculating fees for each organization and recording the fees within a database.

53. The method of claim 52, wherein calculating the fees comprises calculating fees based on at least one of (a) a number of accesses by each organization, (b) a number of label records and label templates stored by each organization, and (c) a subscription fee.

54. A computer-readable medium comprising instructions for causing a processor to:
store configuration data defining plurality of organizations, each organization having at least one group and at least one output location;
present an interface for by which each organization creates corresponding label records; and
selectively print labels at the corresponding output locations for the organizations.

55. The computer-readable medium of claim 54, further comprising instructions for causing a processor to calculate fees for each organization and recording the fees within a database.

56. The computer-readable medium of claim 54, further comprising instructions for causing a processor to calculate fees based at least one of (a) a number of accesses by each organization, (b) a number of label records and label templates stored by each organization, and (c) a subscription fee.

57. A label management system comprising:
means for centrally storing label templates and label records associating label data with the label templates;
means for storing configuration data defining a number of groups within an organization and a number of output locations;
means for controlling updates to the label templates and the label records; and
means for printing labels at the output locations.

58. The label management system of claim 57, further comprising means for storing configuration data defining a number of packaging levels

59. The label management system of claim 57, further comprising means for creating label templates.

60. The label management system of claim 57, further comprising means for creating graphics.
